(19) United States
(12) Patent Application Publication
(10) Pub. No.: US 2017/0216666 A1
(43) Pub. Date: Aug. 3, 2017

(54) Laser guided feedback for rehabilitation and fitness exercises

(71) Applicant: Willem Kramer, Fort Worth, TX (US)

(72) Inventor: Willem Kramer, Fort Worth, TX (US)

(21) Appl. No.: 15/416,092

(22) Filed: Jan. 26, 2017

Related U.S. Application Data
(60) Provisional application No. 62/287,955, filed on Jan. 28, 2016.

(51) Int. Cl. A63B 24/00; G09B 19/00; G09B 5/02; A63B 71/06; A63B 23/04

(52) U.S. Cl. CPC A63B 24/0006; A63B 71/0622; A63B 23/0405; G09B 5/02; G09B 19/0038; A63B 2024/0012; A63B 2071/0647; A63B 2071/0661; A63B 2071/0694; A63B 2023/0411

(57) ABSTRACT

A method for ensuring proper execution of exercises. A user is provided with a means for displaying a visual cue, in one embodiment a laser. The laser is worn by the user on certain areas of the body, for example a joint. The laser is projected and displayed on to a substrate such as a grid. In turn, the user is directed to move, resulting in movement of the visual cue on the grid. Reference points on the grid are compared to the movement of the user, as a result providing feedback from the movement of the user to an extent proper execution of the exercises can be corrected and applied.

### CROSS-REFERENCE TO RELATED APPLICATIONS

The instant application claims benefit of provisional application Ser. No. 62/287,955 filed Jan. 28, 2016, the contents of which are herein incorporated by reference.

### BACKGROUND

Field of Invention

The invention relates to the field of fitness and physical therapy and athletic training. Particularly, laser guided feedback is provided which helps coaches, physical therapists and trainers ensure that clients and patients maintain proper form while performing exercises and execute them correctly.

Description of the Related Art

Currently, coaches, physical therapists and trainers provide verbal and manual cues and manually and orally correct their client or patient as needed. When working on their own clients, clients/patients must trust their “feeling” and administer the use of mirrors to help improve the execution of the suggested exercises. Affordable and easy to use equipment providing visual cues to help fitness enthusiasts and patients execute an exercise properly is not yet known.

Much of the prior art uses lasers as actual treatment instruments. U.S. Patent Pub. No. 2013/0116612 to Stephan shows optical rods which transmit light exteriorly of their length are coupled to one or more lasers at ends. The optical rods are mounted on various carriers or as part of an optical bandage to provide therapeutic light to a portion of a human body.

U.S. Pat. No. 5,616,140 to Prescott describes a battery operated, portable laser bandage having one or many lasers or hyper-red light emitting diodes imbedded therein may be worn by a patient and applied to a specific treatment area. The device supplies the patient with a preprogrammed laser therapy regimen. The patient may wear the device for up to a week between visits to a physician. At the end of the prescribed treatment length or at the end of a week, batteries in the device may be changed or recharged and the physician may re-program the device for a different treatment regimen, if desired. The device is small enough to be worn under clothes and does not interfere with the patient's normal activities.

Other prior art utilizes laser feedback for sports guidance and rehabilitation. For example, U.S. Pat. No. 7,647,649 Vorbuchner a positioning device is applied in a reproducible manner to a patient, allows indication of the position of an anatomical area of the patient, allows the patient to be positioned in a reproducible manner in relation to an examination area of a medical examination device and a therapy area of a therapy device, and includes an antenna arrangement for the examination with a magnetic resonance device. In one embodiment, the positioning device also includes an arrangement for immobilizing the patient. U.S. Publication No. 2008/0191864 to Wolfson teaches an interactive training system capable of generating continuous feedback for physical therapy and training applications based on capturing and analyzing the movement of a user on an interactive surface. Finally, U.S. Pat. Pub. No. 2016/0310341 to YU shows a wearable training device for gait rehabilitation and a method using the same. The power supply unit and the light emitting unit are coupled with each other and disposed on the support member which is attached on a user's lower limb. The trigger unit is contacted to a sole of foot of the lower limb on which the support member is attached, and coupled to the light emitting unit. When the sole of foot is landed, the trigger unit is triggered to activate the light emitting unit to project a visible light on the ground. Therefore, the user can be guided to lift the opposite side leg to step on the stepping prompt point.

There is a need then for a method for ensuring proper execution of rehabilitation and fitness exercises.

### SUMMARY

Comprehended are lasers (laser pointers—max power 5 mW, wavelength 650 nm, class IIIa) worn on a belt strapped to the users' torso and extremities, amplifying joint movements and providing the user with visual cues on the wall and/or floor. An available grid laid out on the floor and hung on the wall provide the user with a grid-range in which to keep the laser, in turn the red dots make it easier for users to track and trace their movement.

The belts with attached lasers are worn proximate to the hips, knees, ankles, elbows, wrists, torso, and/or head, etc. Most suitable points for the laser to “rest on” are bony points—areas of the body that allow a steady surface for the laser during movement. When attached to a certain joint or body part the lasers indicate the position of that particular joint or body-part in relation to other laser-connected joints and body parts during movement.

Users can utilize laser guidance without a grid and follow the laser movements on the wall and/or floor. For additional feedback, an available grid on the floor and wall provide more insight in starting position(s) and position(s) during movement(s).

Accordingly, provided is a method for ensuring proper execution of rehabilitation and fitness exercises, comprising the steps of providing a human user with a means for displaying a visual cue, said means for displaying a visual cue worn by the human user on or near a human user's joint; providing a reference movement pattern; comparing movement of said visual cue to said reference movement pattern, as a result providing feedback from said movement of said user to an extent execution of said movement can be applied and corrected.

### BRIEF DESCRIPTION OF THE DRAWINGS

FIG. 1 shows a parallel laser and holding belt.

FIG. 2 shows a perpendicular laser and holding belt.

FIGS. 3-4 show an example of where a user can position and wear the lasers while exercising.

FIG. 5 shows two perspective views of an example parallel beam laser and enclosure.

FIG. 5A shows two perspective views of an example perpendicular beam laser and enclosure.

FIG. 6 shows front and side views of a standing, roll up banner grid used as the substrate for showing the visual cues.

FIG. 6A shows the general set-up of the standing, roll up banner grid.

FIG. 7 shows a diagrammatic illustration of proper movements of torso related joints with horizontally aligned laser indications.

FIG. 8 shows a diagrammatic illustration of suitable location points for the lasers for the movement of FIG. 7.

FIG. 9 shows a diagrammatic illustration of the sideways movement of the torso-related lasers.

FIG. 10: shows a diagrammatic illustration of the upward movement of one of the torso-related lasers and a downward and out movement of the other torso-related laser.

FIG. 11 shows a diagrammatic illustration of a torso-related laser pattern indicating torsion.

FIG. 12 shows a diagrammatic illustration of a downward movement of both torso-related lasers.

FIG. 13 shows a diagrammatic illustration of an upward movement of both torso-related lasers.

FIG. 14 shows a diagrammatic illustration of a few examples of extremity related laser patterns.

FIG. 15 shows a diagrammatic illustration of incorrect laser pattern during a single leg squat or step down.

FIG. 16 shows a diagrammatic illustration of a correct laser pattern during a single leg squat or step down.

FIG. 17 shows a diagrammatic illustration of a correct laser pattern during a single leg squat or step down on the substrate.

FIG. 18 shows a diagrammatic illustration of a correct laser pattern associated with a double leg squat.

### DETAILED DESCRIPTION OF THE PREFERRED EMBODIMENT

The instant method controls and ensures proper execution and form of rehabilitation and fitness exercises. This means the practical application of the method can be used for any physiotherapy, physical medicine, rehabilitation specialties or any mechanical force and movements that remediate impairments and promote mobility, function, and quality of life through examination, diagnosis, prognosis, and physical intervention. The methodology implements effective movement analysis apparatuses for providing a human user 1 (undergoing the rehabilitation for example) with a means for displaying a visual cue 3. The visual cue 3 means can be a laser 2 or any light beam generating device, making it possible for evaluators (therapists/trainers/coaches and clients/patients) to clearly see the otherwise difficult-to-register movement of joints 4 during physical activity and the position of body-parts in relation to each other during both movement and inactivity. In addition, unlike currently available movement analysis apparatuses, it is easy to use, fast and very affordable. There is no need for body-markers, cameras or complex computer software.

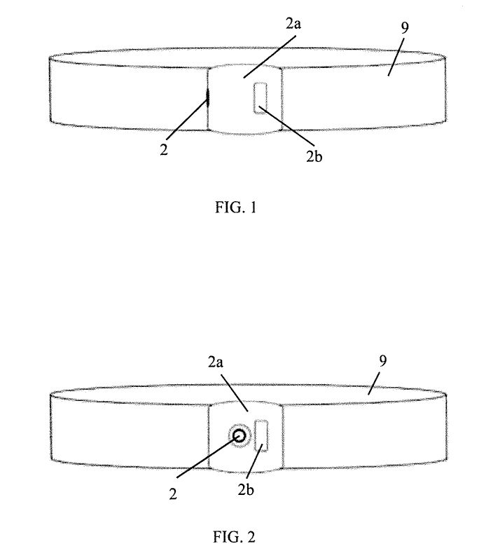

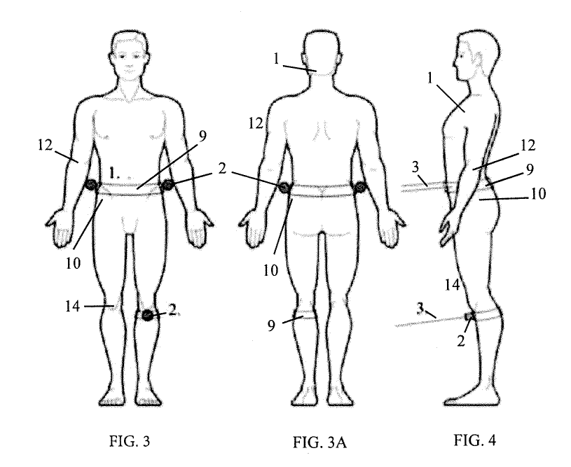

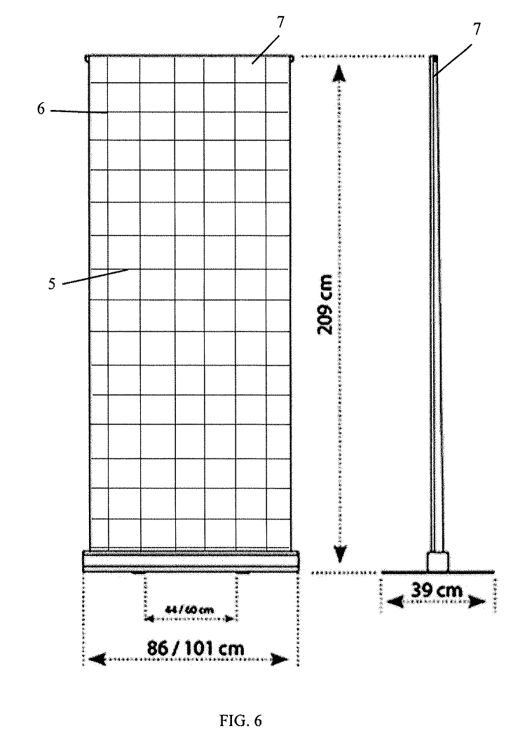

With reference then to FIGS. 1-5, shown is the visual cue 3 generating implements or system, shown in the preferred embodiment as a laser 2 with holding belt 9. In this example, lasers 2 are attached to belt 9. Each laser 2 includes an enclosure 2a, an on/off power button 2b and a USB port 2c for charging. Preferably, one laser 2 generates a “parallel” beam, meaning when worn by user 1 the laser beam is emitted in an “x” direction along the holding belt 9 (see FIGS. 1 and 5). One laser 2 alternatively generates a “perpendicular” beam, meaning when worn by user 1 the laser beam is emitted in a “z” direction out from the holding belt 9 (see FIGS. 2 and 5A for example). The means for securing the laser 2 to the holding belt 9 can take various forms. In one embodiment, the holder (not shown) can be integrated directly as part of belt 9 or be a separate clasp made of a flexible polymer. The laser 2 is inserted into a crevice with a diameter slightly smaller than the diameter of the laser 2. Use of a flexible polymer makes this possible and allows a secure enough bond. The use of the polymer also allows the clasp to bend with and form to the body part it is worn on.

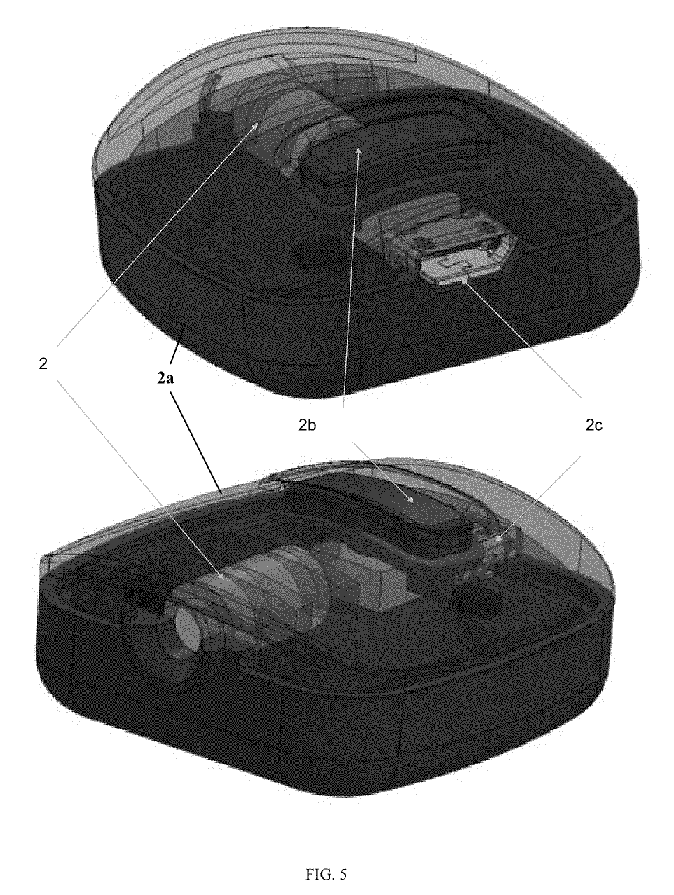

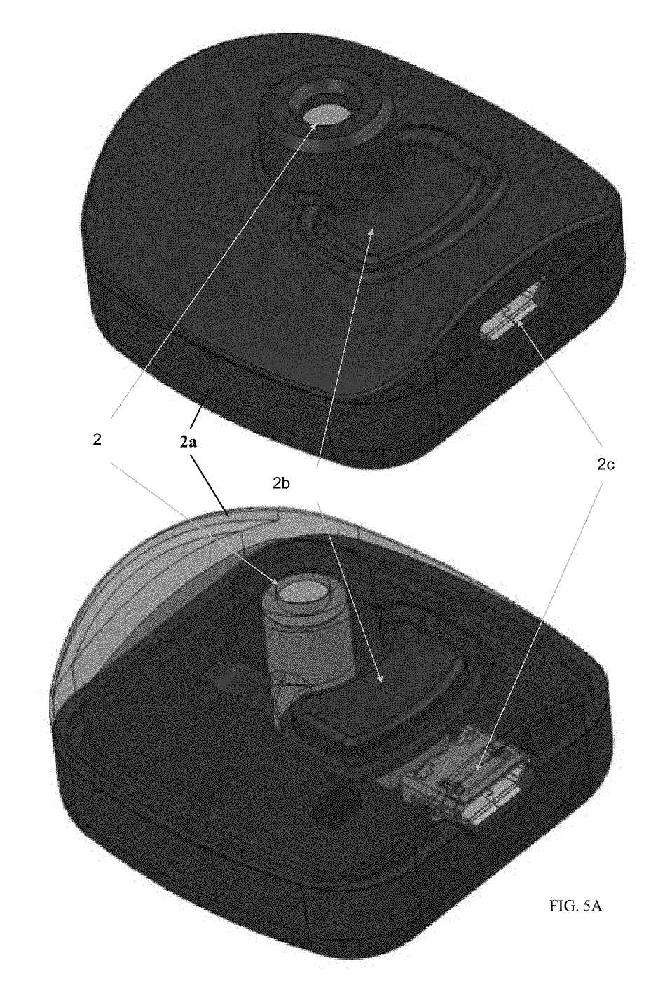

Shown by FIGS. 3-4 is an example of where a user 1 can position (by wearing) the holding belts 9 while exercising. In this particular example, the user 1 wears laser 2 on the widest part of his hips (hip bones) of pelvic region 10 with one perpendicular laser 2 just below the knee 14 cap, e.g. on the patellar ligament. This setup allows the control and proper execution of a single-legged squat, squatting down on one leg, in this particular case the left leg. The user 1 and evaluator can see the laser dots as visual cues 3 on the wall/floor and/or grids placed on the wall/floor and correct hip and knee movements revealed by the movements of the lasers 2, as further described.

FIGS. 5 and 5A show an example laser 2, its enclosure 2a and circuitboard. In one embodiment, the laser 2 can be a laser pointer, max power 5 mW, wavelength 650 nm, class IIIa. Here, the lasers 2 are built on a circuit board containing a rechargeable battery, mini USB port 2c for charging and on/off switch 2b. An enclosure 2a protects the circuit board and laser 2 and allows it to attach to an elastic belt through Velcro, magnets, a clasp or by other means.

As noted above, the lasers 2 preferably come in two (2) different enclosures 2a. One enclosure positions the laser 2 perpendicular in relation to the belt 9, and the other has the laser 2 positioned parallel to the belt 9. Although strapping the laser 2 to any part of the extremities and torso provides data on movement and position of the body parts, it is deemed favorable to strap the laser 2 to a more “bony” part (void of muscles) of the extremity 12 and torso 13. This is done to prevent interference or impeding movement of the visual cues 3 due to expanding and contracting of underlying muscles.

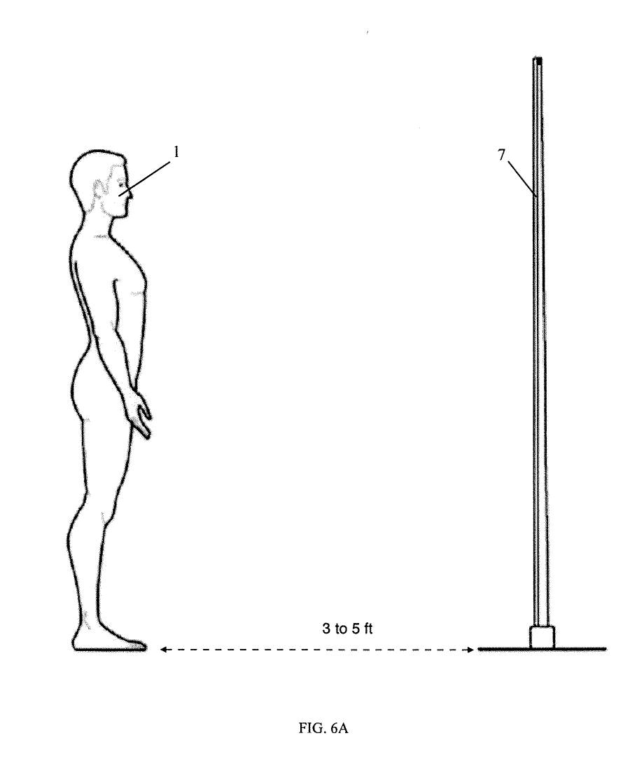

Referencing now FIGS. 6 and 6A, the visual cues 3 are projected and compared to a reference movement pattern 5. Reference movement pattern 5 means a point 8 of reference. The point 8 of reference may be projected onto a vertical or horizontal substrate 7 such as a pre-existing wall or floor. The substrate 7 may also take the form of a white, dry-erase, pull-down sheet or banner (see FIGS. 6 and 6A for example). The substrate 7 may further include a pre-printed grid 6 laid out on the substrate 7 containing the reference points 8. As an example, a grid 6 displaying a 5×5″ printed grid is pulled down over the wall and onto the floor in front of the user or a 5×5″ grid painted on white wall and floor is used to help the evaluator or user 1 to trace the visual cues 3 (laser dots). The horizontal and vertical grid lines make tracking movement easier. For example, the grid 6 makes it easier to trace the horizontal position of the iliac-crest-attached-lasers when performing a single leg squat. The left/right and up/downward movement of the knee-attached-laser is also easier to track. Another application of the grid 6 is for the user to “trace” or follow a pre-drawing, grid trajectory and/or position, again “reference movement pattern” 5. A therapist, coach or trainer can draw a desired laser trajectory and ask the user/patient to follow or maintain said trajectory and/or position. It has been shown that the user 1 should stand about three (3) to five (5) feet from the substrate 7.

In the example set-up of FIGS. 3-4, the lasers 2 are in transverse and parasagittal planes and make it possible to register movement of joints during activity and position of body parts during activity (and inactivity). This registration is accomplished by noting changes in distance and angles between the laser-dot visual cues 3 and the trajectory (path) of individual laser-dots and laser-dots in relation to one another. Through left/right movement within the transverse plane the torso-related lasers 2 indicate rotation of the trunk/torso. An up/down movement of torso-related laser in relation to the other, in other words a reduction in the horizontal distance (within the transverse plane) between laser-dots, indicates a latero-flexion in the vertebral joints, sideways bending of the vertebral column, and a related abduction/adduction movement of the hip and/or shoulder joints. A constant, horizontal distance between torso-related lasers 2 combined with up/down movement of laser 2 in relation to the other indicates a torsion of the pelvis or rib-cage. With the lasers strapped to the pelvic region 10 a downward movement of the laser-dots points toward an extension of the lumber intervertebral joints (increased lumbar lordosis) and flexion of the hip joints. With the same setup an upward movement of the visual cues 3, or dots, indicates an flexion of the lumber intervertebral joints (decreased lumbar lordosis) and extension of the hip joints. With the lasers strapped to the ribcage a downward movement of the laser-dots points toward a flexion of the thoracic intervertebral joints (increased thoracic kyphosis). An upward movement of the dots indicates an extension of the thoracic intervertebral joints (decreased thoracic kyphosis). Lasers on the extremities, projecting dots within the parasagittal planes, indicate internal/external rotation, abduction/adduction, flexion/extension and pronation/supination of the limb or limbs they are strapped to, as further exemplified below. Of course, singular positions and movements (only an abduction/adduction or a flexion/extension movement) are rare. A combination of different laser-dot layouts/positions and movements during is more common.

In addition to indicating joint movement during physical activity the position of the laser-dots in relation to each other say something about the position of the body-parts they are attached to, termed herein “inactivity”. In comparison to the contra-lateral limb (lasers on the contra-lateral limb are necessary) and with the torso-related lasers as a reference, the extremity-related lasers indicate an internal/external rotation, abduction/adduction, flexion/extension and pronation/supination position of said extremities. When used in comparison to an established “norm” torso-related lasers can indicate a flexion/extension, lateroflexion and rotation position of the pelvic region, vertebral column and ribcage.

### EXAMPLES

Referencing again FIG. 4, during use, with a single-legged squat (squatting down on one leg) the lasers 2 here are worn on the hips at pelvic region 10. The dots as the visual cues 3 showing on the wall should be horizontally lined up throughout the movement and cannot veer left or right (they must stay vertical) from the starting position of the movement. The left-hip-worn-laser 2 should be lined up vertically with the laser 2 worn on the left knee 14. The knee-worn-laser should, throughout the movement, stay in a (vertical) line with the starting position of the movement and should be in line with a sagittal plane drawn through the webspace between the 1st and 2nd metatarsal. At the end of the movement the knee-worn-laser should be (at least) within a few inches of the toes/shoe, or closer. Anything other than what is described about should be addressed and corrected. As should be understood by this and the following examples, the circular, diagrammatic illustrations on the figures of the user 1 depict the actual laser and/or the visual cue 3 as would result from the beam of the laser 2, so the two may be deemed to be used and called-out interchangeably. For example, the grey circles represent the starting-points, the black circles represent the end-points. The arrows indicate movement of the lasers and thus the visual cues 3.

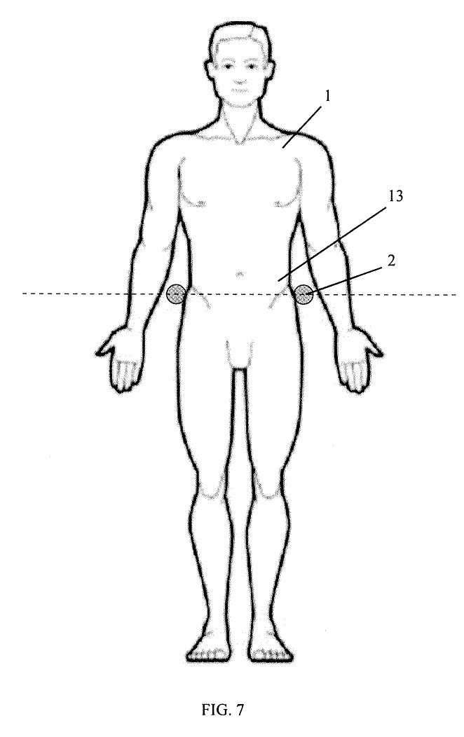

FIG. 7 shows the torso-related lasers 2 worn on or near torso 13 of user 1 to properly show movements of torso related joints, such as the intervertebral, costal and hip joints by which the lasers have to line up horizontally for correct movement.

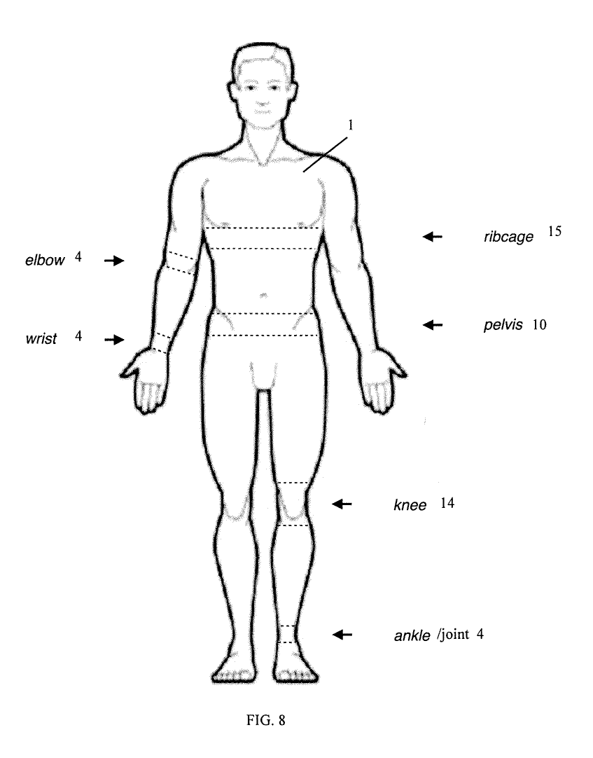

FIG. 8 shows the areas of the user 1 most suitable on which to strap the lasers 2 in each instance of a different exercise. For example, the lasers 2 might be strapped to the pelvis 10, the knee 14, the ribcage 15 or other joint 4 as indicated. The areas in between the dotted lines, indicated by an arrow are mostly void of muscles and therefore provide a more stable underlayment.

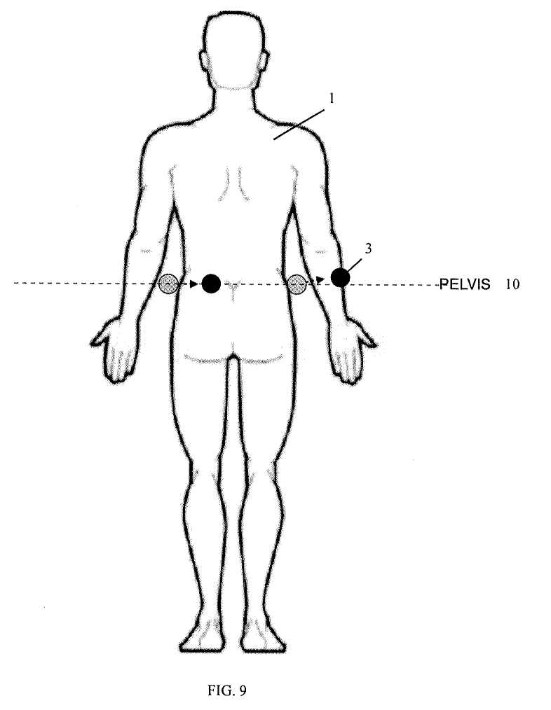

FIG. 9 shows a sideways user 1 movement of the torso-related lasers. With the lasers strapped to the pelvis this visual cue 3 pattern shows a rotation of the back (the intervertebral joints) and the hip joints. The user 1 turns the pelvis 10 to the left and therefore internally rotates the right hip joint and externally rotates the left hip joint. Keeping the shoulders square, the vertebral column rotates to the left. Again, the grey circles represent the starting-points, the black circles represent the end-points. The arrows indicate movement of the lasers and thus the visual cues 3.

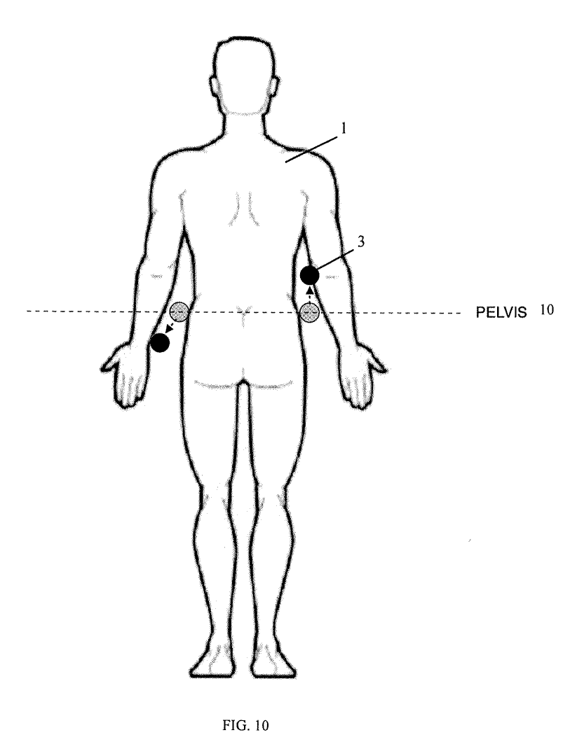

FIG. 10 shows an upward movement of one of the torso-related lasers and a downward and out movement of the other torso-related laser. With the lasers strapped to the pelvis 10 of user 1, this visual cue 3 pattern indicates lateral flexion of the back and adduction and abduction of the hips. The user 1 hikes up the right pelvis and therefore adducts the right hip joint and abducts the left hip joint. The lumbar vertebral column bends to the left.

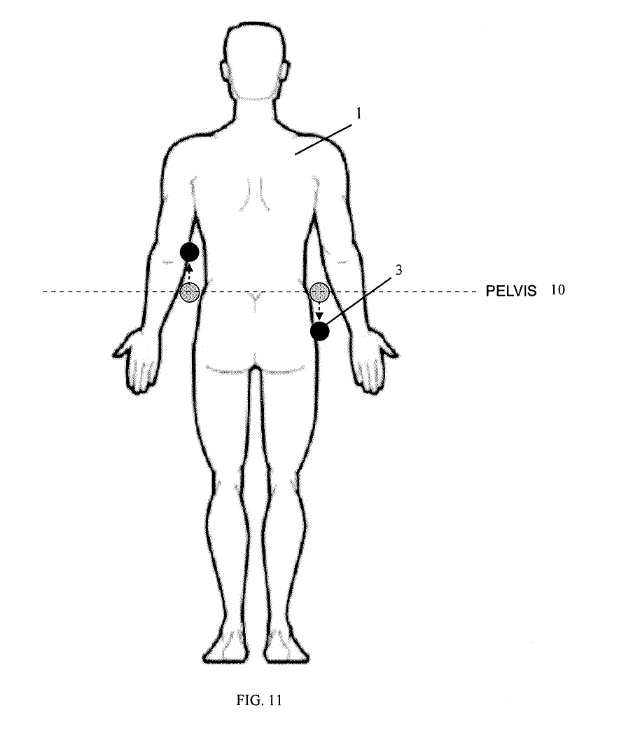

FIG. 11 shows a torso-related laser pattern indicating torsion—also known as nutation and counter nutation—of the sacroiliac (SI) joints with the lasers strapped to the pelvis 10. With the lasers strapped to the hips the user flexes/bents one hip joint while extending the other and therefore creates a torsion (flexion on one side and extension on the other side) in the SI joints. If the laser were on the ribcage (not shown) the user 1 raises one arm while moving the other backward and therefore creates a torsion of the ribcage. With the lasers on the ribcage the downward and upward movement of the individual laser dots indicate a torsion of the ribcage. The grey circles represent the starting-points, the black circles represent the end-points. The arrows indicate movement of the lasers.

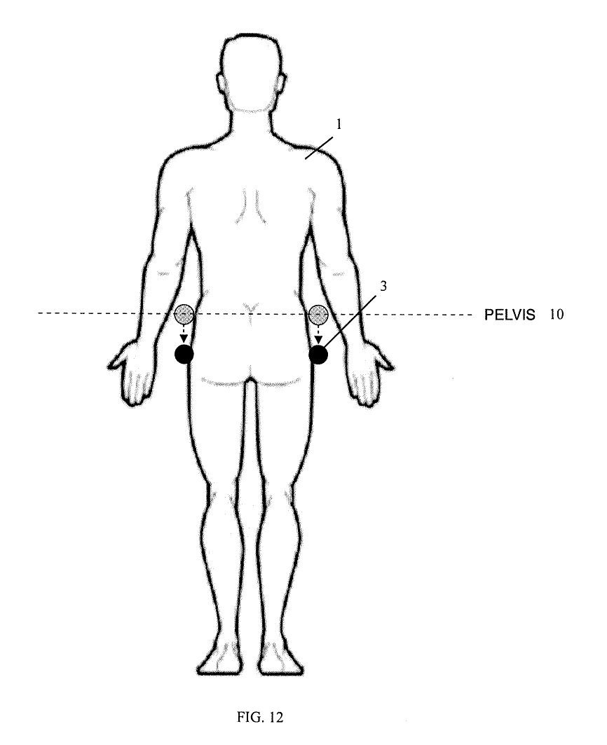

FIG. 12 shows a downward movement of both torso-related lasers. With the lasers strapped to the pelvis 10 this visual cue 3 pattern indicates flexion of the hip joint and extension of the vertebral column. With the lasers strapped to the hips the user arches his/her lower back and therefore flexes both hip joints while extending the intervertebral joints.

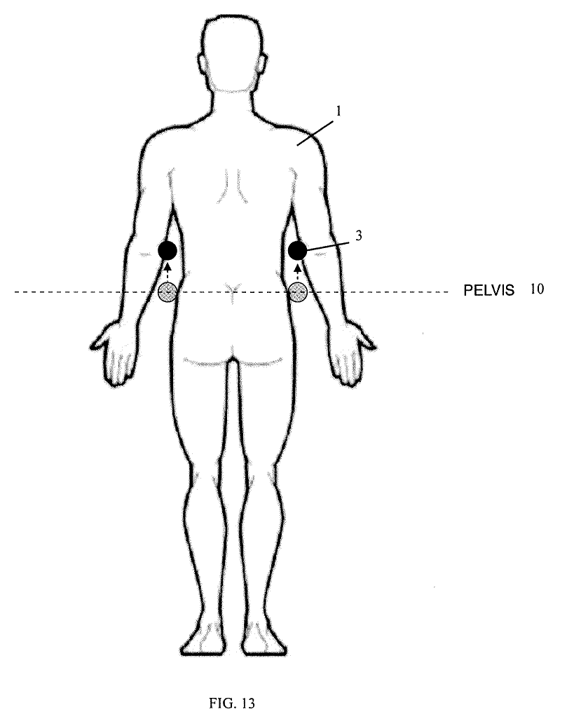

FIG. 13 shows an upward movement of both torso-related lasers. With the lasers on the pelvis 10 this visual cue 3 pattern indicates extension of the hip joint and flexion of the vertebral column. With the lasers strapped to the hips the user rounds his/her lower back and therefore extends both hip joints while flexing (bending) the intervertebral joints. If the lasers were on the ribcage (not shown) the user 1 arches his/her back and therefore extends the intervertebral joints. With the lasers on the ribcage the upward movement of the laser dots indicate an extension of the vertebral column. Again, the grey circles represent the starting-points, the black circles represent the end-points. The arrows indicate movement of the lasers or visual cues 3.

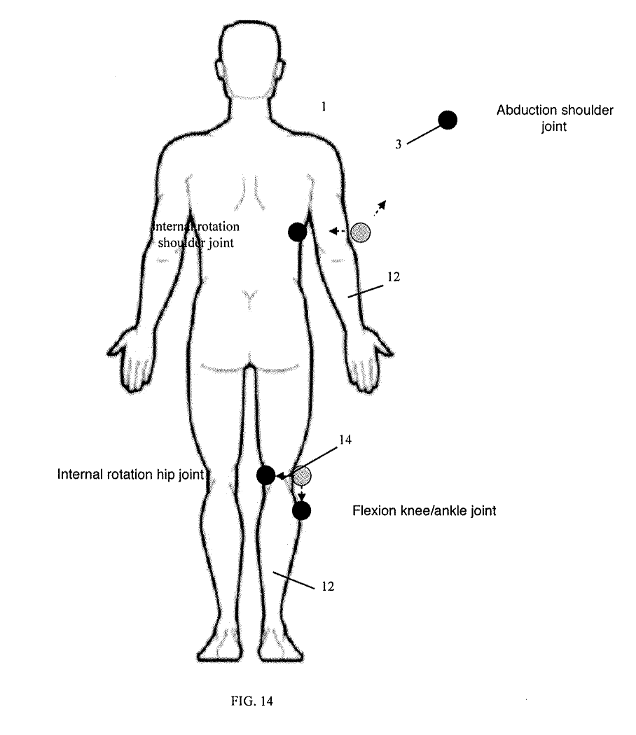

FIG. 14 shows a few examples of extremity related laser visual cues 3 patterns. With the laser strapped just above the elbow (extremity 12) an inward movement of the laser indicates and internal rotation of the shoulder joint. With the laser strapped to the same location, an upward motion indicates an abduction of the shoulder joint. With the laser strapped directly over or just under the knee joint, an inward motion of the laser indicates and internal rotation of the hip joint. A downward motion indicates flexion (bending) of the knee and ankle joint.

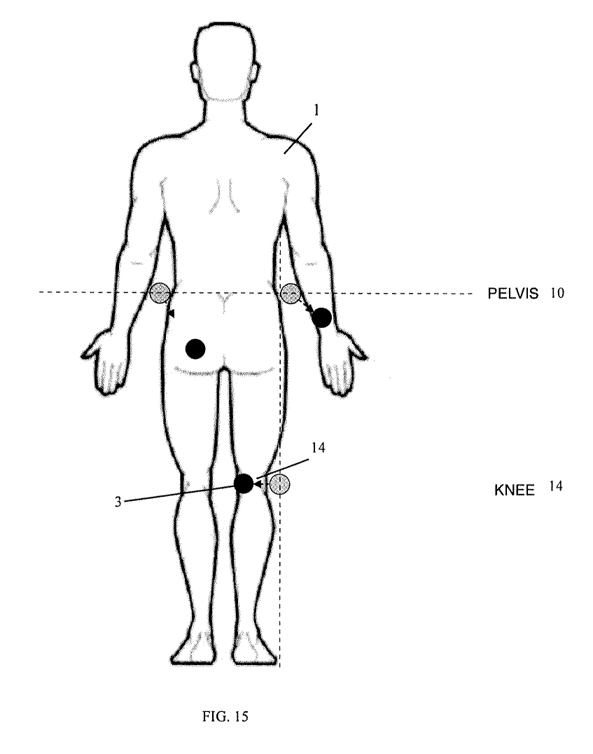

FIG. 15 shows an incorrect laser pattern during a single leg squat or step down by user 1. The torso-related lasers move both downward and inward, the left more so than the right, showing by visual cue 3 that the right hip joint adducts and internally rotates. The knee-related laser and visual cues 3 move inward, confirming the adduction of the hip joint and valgus movement of the knee 14. This often seen, incorrect movement pattern is believed to be associated with, among others, lower back, hip, knee and ankle problems like for example, nonspecific lower back pain, adductor longus strains, ACL tears, patellar tendinitis, sprained ankles.

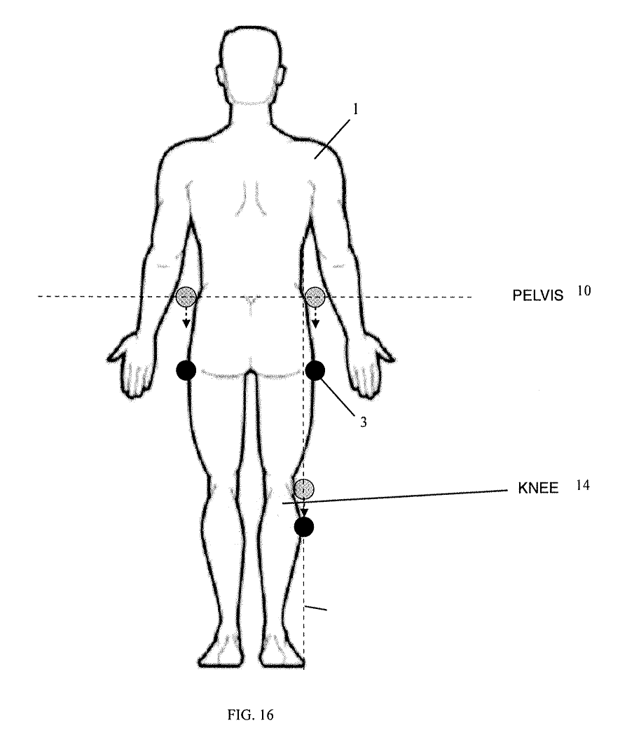

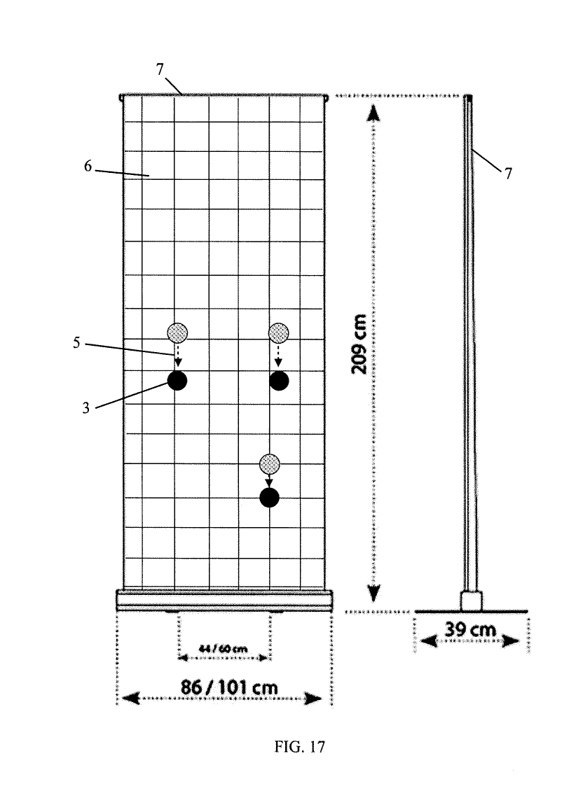

FIG. 16 shows a correct laser visual cue 3 pattern during a single leg squat or step down by user 1. The torso-related lasers move both down showing that the abductor muscles of the right hip joint are capable of keeping the pelvis 10 lined up horizontally when using a single leg (like with walking, jogging and other activities). The knee-related laser moves downward only, confirming the activity of the hip abductors, the knees 14 external rotators and the ankle's supinators. All activity limits unnecessary stress on the lower back, hip, knee and ankle joints. This same movement example is shown on the grid layout 6 of FIG. 17.

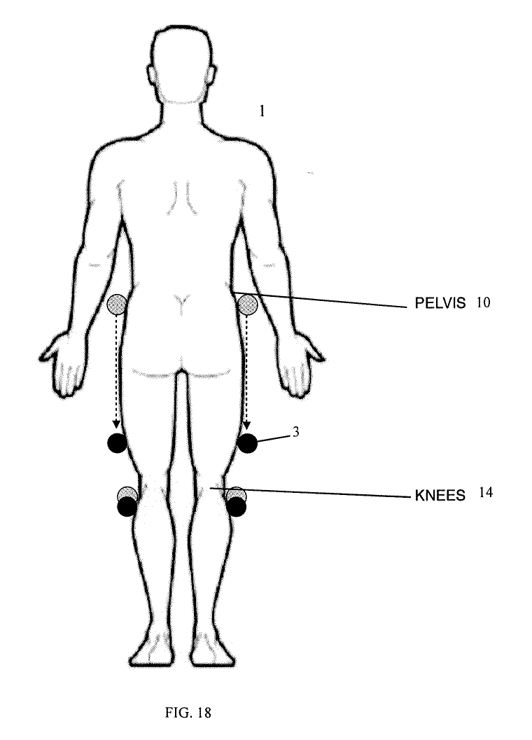

FIG. 18 shows a laser visual cue 3 pattern associated with a double leg squat. Although single leg exercises are favorable, during activity humans generally use their limbs in alternate and not simultaneously, but the lasers can be used during double leg exercises also. The significant downward motion of the pelvis 10 related lasers indicates a flexion of the hip and knee 14 joints. The limited downward motion of the knee 14 related laser indicates a reasonably small flexion of the ankle joint. The pelvis 10 and knee 14 related lasers move toward each other when squatting down and away from each other during the upward part of the motion.

I claim:

1. A method for ensuring proper execution of exercises, comprising the steps of:
providing a user with a means for displaying a visual cue, said means for displaying a visual cue worn by said user;
displaying a grid layout on a substrate, whereon said visual cue can be projected;
directing said user to move, resulting in movement of said visual cue;
correlating points on said grid layout with said proper execution; and,
comparing said movement of said visual cue to said points on said grid layout, as a result providing feedback from said movement of said user to an extent said proper execution can be corrected and applied.

2. The method of claim 1, wherein said means for displaying said visual cue is a laser.

3. The method of claim 2, wherein said laser is disposed on a hip bone of a pelvis of said user and below a knee of said user, thereby indicating motion of a squat.

4. The method of claim 2, wherein said laser is disposed on a torso of said user, thereby indicating rotational motion of said torso.

5. The method of claim 2, wherein said laser is disposed on a rib-cage of said user, thereby indicating extension or flexion of thoracic intervertebral joints.

6. The method of claim 2, wherein said laser is disposed on a pelvic region of said user, thereby indicating an extension or flexion of lumber intervertebral joints and extension or flexion of hip joints.

7. The method of claim 2, wherein said laser is disposed on an extremity of said user, thereby indicating motion of a limb.

8. The method of claim 1, further comprising the step of directing said user to stand in a range of three to five feet from said substrate.

9. A method for ensuring proper execution of exercises, comprising the steps of:
providing a user with a means for displaying a visual cue, said means for displaying a visual cue worn by said user;
directing said user to move, resulting in movement of said visual cue;
providing a reference movement pattern; and,
comparing said movement of said visual cue to said reference movement pattern, as a result providing feedback from said movement of said user to an extent execution of said movement can be corrected and applied.

10. The method of claim 9, wherein said means for displaying said visual cue is a laser.

11. The method of claim 10, wherein said laser is disposed on a hip bone of said user and below a knee of said user, thereby indicating motion of a squat.

12. The method of claim 10, wherein said laser is disposed on a torso of said user, thereby indicating rotational motion of said torso.

13. The method of claim 10, wherein said laser is disposed on a rib-cage of said user, thereby indicating extension or flexion of thoracic intervertebral joints.

14. The method of claim 10, wherein said laser is disposed on a pelvic region of said user, thereby indicating an extension or flexion of lumber intervertebral joints and extension or flexion of hip joints.

15. The method of claim 10, wherein said laser is disposed on an extremity of said user, thereby indicating motion of a limb.

16. The method of claim 9, wherein said reference movement pattern is a vertical line.

17. The method of claim 9, wherein said reference movement pattern is a horizontal line.

18. The method of claim 9, further comprising the step of directing said user to stand in a range of three to five feet from said substrate.

19. A method for ensuring proper execution of exercises, comprising the steps of:
wearing a laser on a body part, wherein said body part is selected from the group consisting of a hip bone, a knee, a torso, a pelvis, a rib-cage, and a limb;
projecting said laser on to a substrate, wherein said substrate includes a reference movement pattern; and,
moving said body part, wherein movement of said laser is compared to said reference movement pattern, as a result providing feedback from said movement to an extent execution of said movement can be corrected and applied.
